(19) United States
(12) Patent Application Publication
(10) Pub. No.: US 2008/0005411 A1
(43) Pub. Date: Jan. 3, 2008

(54) Audio signal Input/Output (I/O) system and method for use in guitar equipped with Universal Serial Bus (USB) interface

(75) Inventor: Min-Soo Kim, Incheon (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: ESI Professional

(21) Appl. No.: 11/399,760

(22) Filed: Apr. 7, 2006

(51) Int. Cl. G06F 13/38

(52) U.S. Cl. 710/62

(57) ABSTRACT

An audio I/O system and method for a guitar equipped with a USB interface is disclosed. The audio I/O system converts an analog audio signal generated from an electronic guitar into a digital audio signal using a USB guitar module of the electronic guitar, performs signal processing on the digital audio signal according to the USB standard, transmits the signal-processed resultant signal to a Personal Computer (PC), employs a variety of application programs stored in the PC, and outputs the corresponding audio signal via a speaker of the PC. The audio I/O system receives the mixed/edited signal from the PC, performs signal processing on the received signal, outputs the corresponding signal via the headphone or speaker, allows the PC to output pre-stored audio signals of other guitars, plays the electronic guitar, and stores the played signal in the PC in real time.

### BACKGROUND OF THE INVENTION

1. Field of the Invention

The present invention relates to an audio Input/Output (I/O) system and method for use in a guitar equipped with a Universal Serial Bus (USB) interface, and more particularly to an audio I/O system and method for providing a Personal Computer (PC) with digital audio signals generated by an electronic guitar equipped with a bi-directional USB interface unit, and storing the digital audio signals in the PC, at the same time outputting the aforementioned audio signals or other guitars' audio signals received from the PC to a speaker or a headphone while a plurality of electronic guitars are simultaneously played, and more conveniently employing a variety of audio edition programs contained in the PC.

2. Description of the Related Art

As well known in the art, with the increasing development of electronic communication technologies, data generated from an auxiliary device is effectively transmitted to a personal computer (PC), such that a variety of effects unavailable in the auxiliary device can be accomplished using a variety of edition programs stored in the PC.

For example, a digital camera includes a USB port, such that digital image data captured by the digital camera is transmitted to the PC via the USB port, such that the image data captured by various edition programs (e.g., a photoshop) can be edited in various ways. Therefore, compared with a conventional camera, the digital camera can quickly upload the captured image to the PC, can quickly display the updated image on a PC monitor, and can also quickly use a variety of video edition programs.

A variety of audio edition programs capable of editing/mixing a variety of audio signals have been recently developed. However, in order to employ the above-mentioned audio edition programs, analog audio data generated from a microphone, a guitar, or a keyboard instrument should be firstly recorded, the recorded analog audio data should be converted into digital audio data via an additional encoder, and the digital audio data should be transmitted to the PC via an additional interface, such that a long period of time should be unnecessarily consumed to upload audio data to the PC.

Particularly, audio signal generated from a microphone, a guitar, or a keyboard instrument is configured in the form of an analog signal, such that a recording process is requisite for the analog audio signal. Provided that the analog audio signal is not recorded in a soundproofed recording room wherein the soundproofing process is completely executed during the recording of the audio signal, a plurality of noise signals may be further included in the analog audio signal. In order to solve the above-mentioned problems, an additional filtering process is required, resulting in the occurrences of an unnecessary increase of time and costs.

There has recently been developed a new technique for including a USB interface in a digital instrument to transmit digital audio signals generated from a digital keyboard instrument to a PC via the USB interface. However, the digital keyboard instrument equipped with the USB interface has been designed to uni-directionally transmit digital audio signals to the PC via the USB interface, such that it cannot simultaneously play a plurality of digital keyboard instruments. In addition, if a digital audio signal generated from one keyboard instrument is outputted via a speaker after being stored in the PC, a user must play the other digital keyboard instrument according to the corresponding digital audio signal, such that the above-mentioned keyboard instruments can be simultaneously played in correct rhythm and sound. Therefore, the above-mentioned conventional art cannot automatically perform a mixing process in real time, and commands a PC to perform the mixing process using an additional mixing program so as to create simultaneous-played audio signals.

Particularly, a musical instrument (e.g., an electronic guitar) equipped with the above-mentioned USB interface has not yet been developed. There must be developed an improved USB interface for allowing a plurality of electronic guitars to be played in real time or to simultaneously mix audio signals generated from the electronic guitars.

### SUMMARY OF THE INVENTION

Therefore, the present invention has been made in view of the above problems, and it is an object of the present invention to provide an audio Input/Output (I/O) system and method for use in a guitar equipped with a Universal Serial Bus (USB) interface, which provide a Personal Computer (PC) with digital audio signals generated by an electronic guitar equipped with a bi-directional USB interface unit, and store the digital audio signals in the PC, at the same time output the aforementioned audio signals or other guitars' audio signals received from the PC to a speaker or a headphone while a plurality of electronic guitars are simultaneously played, and more conveniently employ a variety of audio edition programs contained in the PC.

In accordance with one aspect of the present invention, the above and other objects can be accomplished by an audio Input/Output (I/O) system for use in a guitar equipped with a Universal Serial Bus (USB) comprising: an electronic guitar including: a USB port to implement a bidirectional USB interface, a USB guitar module for performing signal processing on a guitar's audio signal converted into an electrical signal, transmitting the signal-processed audio signal to the USB port, performing signal processing on the audio signal received from the USB port, and outputting the resultant audio signal to the outside, and an audio cable port in which an audio cable connector can be inserted; and a Personal Computer (PC) for receiving the audio signal via the USB guitar module and a USB cable of the electronic guitar, converting the received audio signal according to a prescribed audio signal standard, editing/storing the converted audio signal using a variety of mixing programs and audio edition programs, transmitting pre-stored audio signals of other electronic guitars to the electronic guitar via the USB cable and the USB guitar module, and outputting the resultant audio signal to a speaker and a headphone via the audio cable of the electronic guitar.

Preferably, the electronic guitar includes: a signal pickup unit for converting variations in a magnetic field signal caused by string vibrations into an electric analog audio signal; a pickup selection unit for performing a switching operation to output the analog audio signal picked up by the signal pickup unit to a rear end; an audio cable port for acting as a connection port of the connector of the audio cable suitable for ¼″ TRS standard; a relay for switching Input/Output (I/O) paths of an audio signal on the condition that it has been connected to the pickup selection unit, the audio cable port, an amplifier, and L/R amplifiers; an amplifier which is connected to the relay and an ADC (Analog-to-Digital Converter), and amplifies the analog audio signal received from the relay; an ADC which is connected to the amplifier and a signal processor, and converts the analog signal into a digital signal; a signal processor which is connected to the ADC and a DAC (Digital-to-Analog Converter), receives a digital audio signal from the ADC, converts the received digital audio signal into another audio signal according to the prescribed USB transfer standard, receives the audio signal suitable for the USB transfer standard from the PC, and converts the received audio signal into a digital audio signal; an interface unit which is connected to the signal processor and the USB port, receives parallel data suitable for the USB transfer standard from the signal processor, stores the received parallel data in a buffer, converts the stored parallel data into serial data, transmits the serial data, converts the serial data received from an external part into parallel data, and transmits the parallel data to the signal processor; a USB port which is connected to a rear end of the interface unit, and transmits the audio signal received from the interface unit to the PC via the USB cable connector; a DAC which is connected to the signal processor and the L/R amplifiers, receives two parallel digital audio data via the signal processor, and converts the received parallel digital audio data into stereo analog audio data; and L/R amplifiers which are connected to the DAC, the relay, and the audio cable port, and amplify the analog audio signal.

Preferably, the Personal Computer (PC) includes: a USB port which is contained in the PC, is connected to the USB cable connector, receives an audio signal in the PC via the USB cable connector, or transmits an internal signal of the PC to the electronic guitar via the USB cable connector; an interface unit which is connected to the USB port and a USB controller, and communicates with Operating Systems (OSs) of different hardware architectures; a USB controller which is connected to the interface unit and a USB audio drive, converts the audio signal received from the USB port into a signal usable in a kernel, and transmits a signal used in the kernel into other signal according to the USB transfer standard; a USB audio drive which is connected to the USB controller and a data initialize unit, converts the signal usable in the kernel level into an audio signal usable in a user level, or converts the audio signal usable in the user level into the signal usable in the kernel level; a data initialize unit which is connected to the USB audio drive and an audio signal processor, initializes the audio signal according to an international audio application standard, converts data suitable for the international audio application into an audio signal, and defines the number of audio channels, an execution frequency, and a buffer size; and an audio signal processor which is connected to the data initialize unit, converts the audio data received from the data initialize unit, tunes musical sound characteristics of the audio data, records/stores the audio data, reproduces the stored audio data, converts the stored audio data, and transmits the resultant audio data to the data initialize unit.

In accordance with one aspect of the present invention, there is provided an audio Input/Output (I/O) method for use in a guitar equipped with a Universal Serial Bus (USB) comprising the steps of: ST-100) converting a signal of the electronic guitar into other signal suitable for a USB standard, and transmitting the converted signal to a Personal Computer (PC); ST-200) converting a guitar's audio signal received from the PC into another audio signal usable in an application program; ST-300) editing, mixing, and storing the audio signal using the application program stored in the PC; ST-400) transmitting audio data processed by the PC to an electronic guitar; and ST-500) outputting the audio signal received in the electronic guitar via an external output unit of the electronic guitar.

Preferably, the step (ST-100) includes the steps of: converting variations in a magnetic field signal caused by string vibration of the guitar into an analog audio signal; transmitting the analog audio signal into a relay contained in a USB guitar module, and transmitting the resultant audio signal to an amplifier according to a switching operation of the relay; amplifying, by the amplifier, the analog audio signal received from the relay to an ADC (Analog-to-Digital Converter); converting, by the ADC, the analog signal received from the amplifier to the digital signal; converting, by a signal processor, the digital signal received from the ADC into another audio signal according to the USB transfer standard; receiving parallel data suitable for the USB transfer standard in an interface unit, storing the received parallel data in a buffer, and converting the stored parallel data into serial data; and receiving the serial data in the USB port, and transmitting the received serial data to the PC via the USB cable connector.

Preferably, the step (ST-200) and the step (ST-300) include the step of: receiving a signal received from the electronic guitar via a USB port of the PC; allowing an interface unit to communicate with Operating Systems (OSs) of different hardware architectures, allowing a USB controller to receive the signal suitable for the USB transfer standard from the interface unit, and converting the received signal into a signal usable in a kernel; allowing a USB audio drive to receive the signal usable in the kernel, and converting the received signal into an audio signal usable in a user level; initializing, by a data initialize unit, the audio signal according to an international audio application standard; and converting, by an audio signal processor, the audio data received from the data initialize unit into another audio data, tuning musical sound characteristics of the audio data, recording/storing the audio data, reproducing the stored audio data, and converting the stored audio data.

Preferably, the signal transmitted from an audio signal processor of the PC to a data initialize unit is not equal to an audio signal of a currently-playing electronic guitar, and other pre-stored audio signals of other electronic guitars can be transmitted to the data initialize unit, wherein the audio signal processor outputs the audio signal stored in the PC to the outside, at the same time receives the played signal of the electronic guitar, and can store the played signal in the PC in real time.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram illustrating an audio I/O system for use in a guitar equipped with a USB interface in accordance with a preferred embodiment of the present invention;

FIG. 2 is a circuit diagram of a guitar equipped with a USB interface in accordance with a preferred embodiment of the present invention;

FIG. 3 is a block diagram illustrating a Personal Computer (PC) contained in an audio I/O system for use in a guitar equipped with a USB interface in accordance with a preferred embodiment of the present invention; and

FIG. 4 is a flow chart illustrating an audio I/O system for use in a guitar equipped with a USB interface in accordance with a preferred embodiment of the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

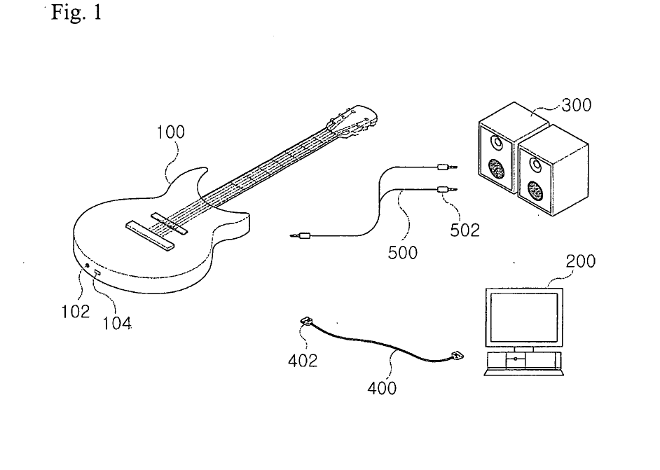

FIG. 1 is a schematic diagram illustrating an audio I/O system for use in a guitar equipped with a USB interface in accordance with a preferred embodiment of the present invention.

Referring to FIG. 1, an audio I/O system for use in a guitar equipped with a USB interface according to the present invention provides a PC with digital audio signals generated by an electronic guitar equipped with a bi-directional USB interface, and stores the digital audio signals in the PC, at the same time outputs the aforementioned audio signals or other guitars' audio signals received from the PC to a speaker or a headphone while a plurality of electronic guitars are simultaneously played, and more conveniently employs a variety of audio edition programs contained in the PC.

In order to perform the above-mentioned operations, the audio I/O system of a guitar equipped with a USB interface includes an electronic guitar 100 equipped with a bi-directional USB interface. The electronic guitar 100 includes an audio cable port 102 in which a cable connector 502 of a general audio cable 500 can be inserted, and includes a USB port 104 in which a cable connector 402 of a USB cable 400 can be inserted.

The electronic guitar 100 includes a USB guitar module 106. The USB guitar module 106 performs signal processing on the guitar's audio signal converted into an electrical signal, transmits the signal-processed audio signal to the USB port 104, performs signal processing on the audio signal received from the USB port 104, and outputs the resultant audio signal to the outside.

The audio I/O system for use in a guitar equipped with the USB interface according to a preferred embodiment of the present invention includes a Personal Computer (PC) 200. The PC 200 receives an audio signal from the guitar 100 via the USB guitar module 106 and the USB cable 400, converts the received audio signal into another audio signal according to the prescribed audio signal standard, edits/stores the converted audio signal using a variety of mixing programs and audio edition programs, and transmits pre-stored audio signals of other electronic guitars to the electronic guitar 100 via the USB cable 400 and the USB guitar module 106, such that it outputs the resultant audio signal to the speaker 300 and a headphone (not shown) via the audio cable 500 of the electronic guitar 100.

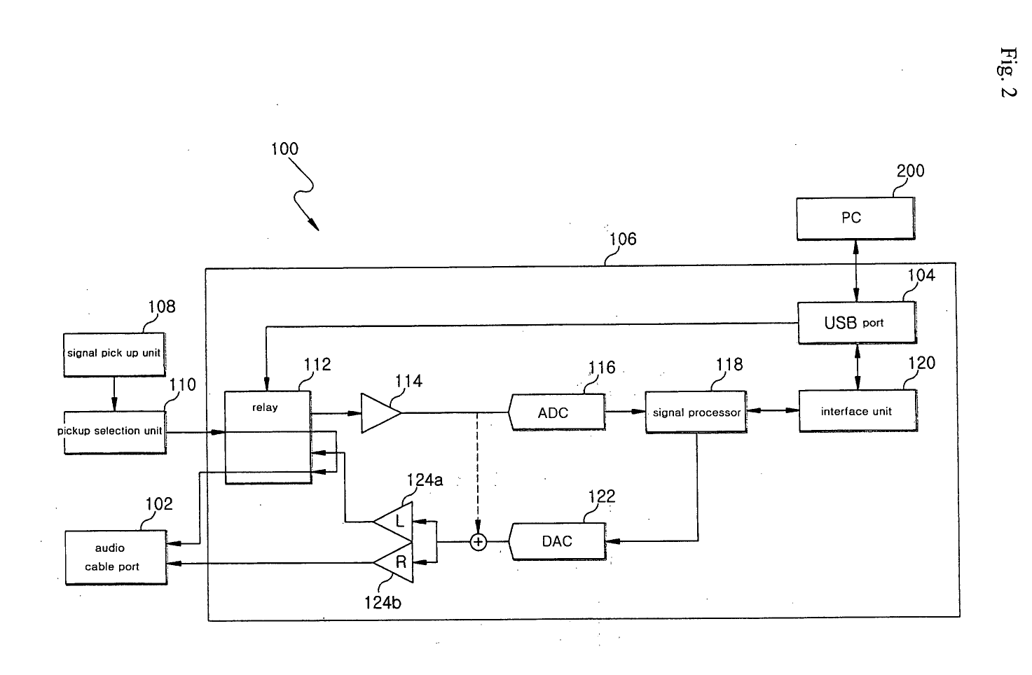

FIG. 2 is a circuit diagram of a guitar equipped with a USB interface in accordance with a preferred embodiment of the present invention.

Referring to FIG. 2, according to the audio I/O system of the guitar equipped with the USB interface according to the present invention, the electronic guitar 100 includes a signal pickup unit 108, a pickup selection unit 110, an audio cable port 102, and a USB guitar module 106.

The signal pickup unit 108 converts variations in a magnetic field signal caused by string vibrations of the guitar into an analog audio signal. The pickup selection unit 108 outputs the analog audio signal picked up by the signal pickup unit 108 to the USB guitar module 106. The audio cable port 102 acts as a connection port of the connector 502 of the audio cable 500 suitable for ¼″ TRS standard.

The USB guitar module 106 includes a relay 112, an amplifier 114, an Analog-to-Digital Converter (ADC) 116, a signal processor 118, an interface unit 120, a USB port 104, a Digital-to-Analog Converter (DAC) 122, a L-amplifier 124a, and a R-amplifier 124b.

The relay 112 switches I/O paths of an audio signal on the condition that it has been connected to the pickup selection unit 110, the audio cable port 102, the amplifier 114, and the L/R amplifiers 124a and 124b. For example, an analog audio signal generated from the pickup selection unit 110 via the relay 112 is applied to the amplifier 114, and is transmitted to the PC 200 via the amplifier 114. The audio signal received from the PC 200 is transmitted to the outside via the audio cable port 102 via the L/R amplifiers 124a and 124b. The relay 112 performs a path switching operation, such that it transmits the analog audio signal generated from the pickup selection unit 110 to the audio cable port 102, and outputs the analog audio signal to the outside.

The amplifier 112 is connected to the relay 112 and the ADC 116, and amplifies the analog audio signal received from the relay 112. The ADC 116 is connected to the amplifier 114 and the signal processor 118, and converts the analog signal into a digital signal. Typically, the ADC 116 converts a mono-analog audio signal into a mono-digital signal.

The signal processor 118 is connected to the ADC 116 and the DAC 122. The signal processor 118 receives the digital audio signal from the ADC 116, converts the received digital audio signal into another audio signal according to the prescribed USB transfer standard, and outputs the resultant audio signal to the PC 200. Otherwise, the signal processor 118 receives the audio signal suitable for the USB transfer standard from the PC 220, converts the received audio signal into a digital audio signal, and transmits the digital audio signal to the DAC 122.

The interface unit 120 is connected to the signal processor 118 and the USB port 104. The interface unit 120 receives parallel data suitable for the USB transfer standard from the signal processor 118, stores the received parallel data in a buffer, converts the stored parallel data into serial data, and transmits the serial data. Otherwise, the interface unit 120 converts the serial data received from an external part into parallel data, and transmits the parallel data to the signal processor 118.

The USB port 104 is connected to the rear end of the interface unit 120, and is connected to the USB cable connector 402, such that it transmits an audio signal received from the interface unit 120 to the PC 200 via the USB cable connector 402.

The DAC 122 is connected to the signal processor 118 and the L/R amplifiers 124a and 124b, receives two parallel digital audio data via the signal processor, converts the received parallel digital audio data into stereo analog audio data, and outputs the stereo analog audio data to the L/R amplifiers 124a and 124b.

The L/R amplifiers 124a and 124b are connected to the DAC 122, the relay 112, and the audio cable port 102, and amplify the analog audio signal. One channel signal from among stereo analog audio signals received from the DAC 122 is transmitted to the audio cable port 102 via the relay 112, and the other channel signal is directly transmitted to the audio cable port 102.

Therefore, the analog audio signal generated from the electronic guitar 100 is converted into a digital audio signal via the USB guitar module 106 of the electronic guitar 100, and at the same time the digital audio signal is signal-processed to be suitable for the USB standard. As a result, the USB guitar module 106 transmits the resultant audio signal to the PC 200, can apply the resultant audio signal to a variety of application programs stored in the PC 200, and can output the resultant audio signal via a speaker of the PC 200.

Also, the USB guitar module 106 receives a mixed/edited signal from the PC 200, and performs signal processing on the received mixed/edited signal, such that it can output the signal-processed resultant signal to the outside via the headphone and speaker 300 connected to the electronic guitar 100. As a result, the USB guitar module 106 receives pre-stored audio signals of other guitars from the PC 200, outputs the received audio signals, at the same time receives the played signal of the electronic guitar 100, and stores the played signal of the electronic guitar 100 in the PC 200 in real time.

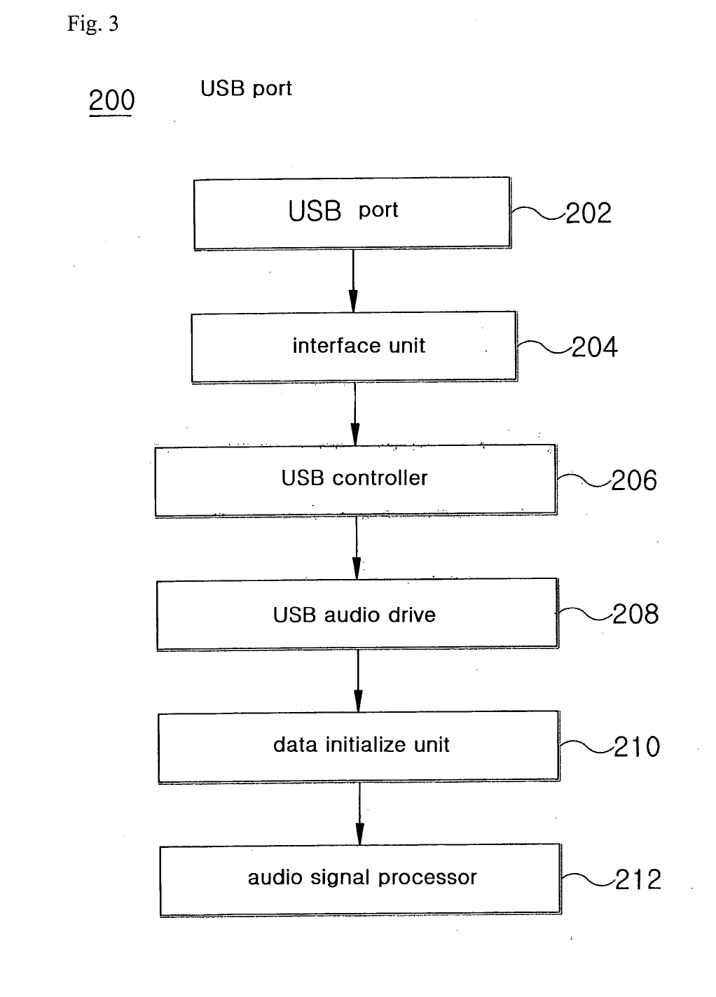

FIG. 3 is a block diagram illustrating a Personal Computer (PC) contained in an audio I/O system for use in a guitar equipped with a USB interface in accordance with a preferred embodiment of the present invention.

Referring to FIG. 3, the PC 200 contained in the audio I/O system of a guitar equipped with the USB interface according to the present invention includes a USB port 202, an interface unit 204, a USB controller 206, a USB audio drive 208, a data initialize unit 210, and an audio signal processor 212.

The USB port 202 is contained in the PC 200, is connected to the USB cable connector 402, receives an audio signal in the PC 200 via the USB cable connector 402, or transmits an internal signal of the PC 200 to the electronic guitar 100 via the USB cable connector 402.

The interface unit (HAL) 204 acts as a virtual interface connected to the USB port 202 and the USB controller 206, such that it can communicate with Operating Systems (OSs) of different hardware architectures. In more detail, the interface unit 204 allows the signal received from the interface unit 204 to be recognized by the USB controller 206, and transmits the signal received from the USB controller 206 to the USB port 202.

The USB controller 206 is connected to the interface unit (HAL) 204 and the USB audio drive 208, and converts an audio signal received from the USB port 202 into a signal usable in a kernel. Otherwise, the USB controller 206 transmits a signal used in the kernel into other signal according to the USB transfer standard.

The USB audio drive 208 is connected to the USB controller 206 and the data initialize unit 210, converts the signal usable in the kernel level into an audio signal usable in a user level, or converts the audio signal usable in the user level into the signal usable in the kernel level.

The data initialize unit 210 (UG-1 ASIO Drive) is connected to the USB audio drive 208 and the audio signal processor 212, initializes the audio signal according to the international audio application standard, and converts data suitable for the international audio application into an audio signal, such that the number of audio channels, an execution frequency, and a buffer size are defined by the data initialize unit 210 (UG-1 ASIO Drive).

The audio signal processor 212 is connected to the data initialize unit 210 (UG-1 ASIO Drive), and converts the audio data received from the data initialize unit 210 (UG-1 ASIO Drive). Therefore, the audio signal processor 212 tunes musical sound characteristics of the audio data, records/stores the audio data, reproduces the stored audio data, converts the stored audio data, and transmits the resultant audio data to the above-mentioned data initialize unit 210 (UG-1 ASIO Drive).

The audio signal processor 212 can employ a variety of application programs stored in the PC 200, and can output the resultant audio signal via the speaker of the PC 200. Also, the audio signal processor 212 receives the mixed/edited signal from the PC 200, performs signal processing on the received signal, outputs the resultant signal to the outside via the headphone and speaker 300 connected to the electronic guitar 100. Also, the audio signal processor 212 outputs the audio signal pre-stored in the PC 200 to the outside via the headphone and speaker 300 connected to the electronic guitar 100, at the same time receives the played signal of the electronic guitar 100, and stores the played signal of the electronic guitar 100 in the PC 200 in real time.

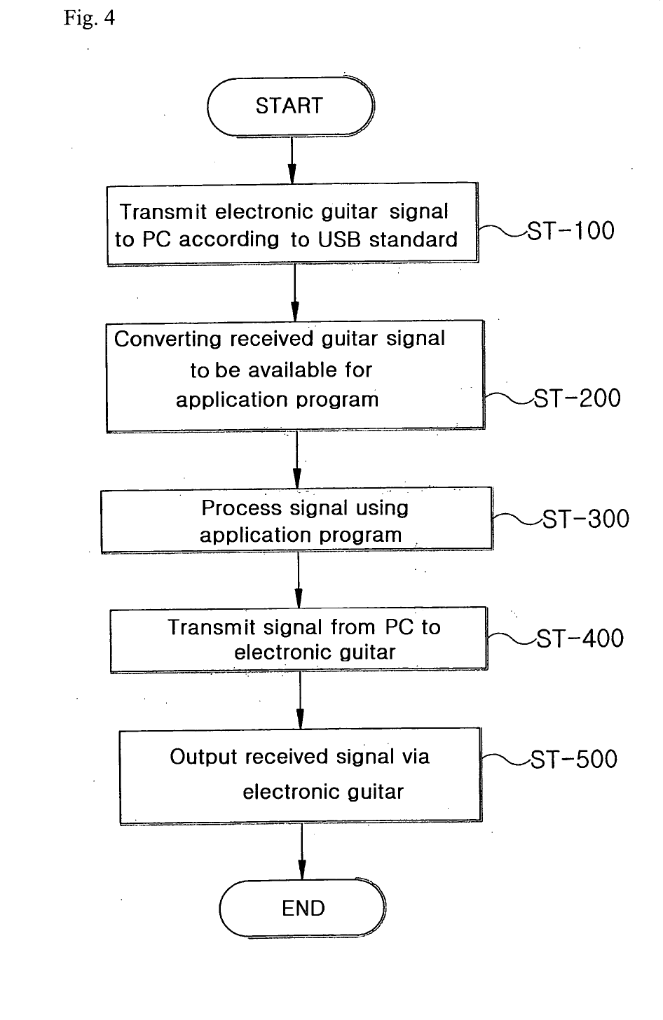

Functions and operations of the audio I/O system for use in the guitar equipped with the USB interface according to the present invention will hereinafter be described with reference to FIG. 4.

FIG. 4 is a flow chart illustrating an audio I/O system for use in a guitar equipped with a USB interface in accordance with a preferred embodiment of the present invention.

Referring to FIG. 4, the audio I/O system for use in the guitar equipped with the USB interface according to the present invention includes the steps of: ST-100) converting a signal of the electronic guitar 100 into other signal suitable for the USB standard, and transmitting the converted signal to the PC 200; ST-200) converting the guitar's audio signal received from the PC 200 into another audio signal usable in an application program; ST-300) editing, mixing, and storing the audio signal using the application program stored in the PC 200; ST-400) transmitting audio data processed by the PC 200 to the electronic guitar 100; and ST-500) outputting the audio signal received in the electronic guitar 100 via an external output unit (e.g., a speaker or a headphone) of the electronic guitar 100.

The above-mentioned step (ST-100) which converts the audio signal of the electronic guitar 100 according to the USB standard and transmits the converted signal to the PC 200 includes the steps of: converting variations in a magnetic field signal caused by string vibration of the guitar into an analog audio signal; transmitting the analog audio signal into the relay 112 contained in the USB guitar module 106; and transmitting the resultant audio signal to the amplifier 114 according to the switching of the relay 112.

The amplifier 114 amplifies the analog audio signal received from the relay 112 to the ADC 116. The ADC 116 converts the analog signal received from the amplifier 114 to the digital signal.

The digital signal is applied to the signal processor 118. The signal processor 118 converts the digital audio signal received from the ADC 116 into another audio signal according to the USB transfer standard, and transmits the resultant audio signal to the interface unit 120. The interface unit 120 receives parallel data suitable for the USB transfer standard from the signal processor 118, stores the received parallel data in the buffer, converts the stored parallel data into serial data, and transmits the serial data.

The USB port 104 receives the serial data, and transmits the received serial data to the PC 200 via the USB cable connector 402.

The above-mentioned step (ST-200) for converting the guitar's audio signal received from the PC 200 into another audio signal usable in an application program, and the above-mentioned step (ST-300) for editing, mixing, and storing the audio signal using the application program stored in the PC 200 are executed by the PC 200, and their detailed descriptions will hereinafter be described in detail.

The PC 200 receives a signal received from the electronic guitar 100 via the USB port 202, and transmits the received signal to the interface unit (HAL) 204, such that the interface unit (HAL) 204 communicates with Operating Systems (OSs) of different hardware architectures and transmits the signal to the USB controller 206.

The USB controller 206 receives the signal suitable for the USB transfer standard from the interface unit (HAL) 204, converts the received signal into the signal usable in the kernel, and transmits the converted signal to the USB audio drive 208.

The USB audio drive 208 receives the signal usable in the kernel level from the USB controller 206, and converts the received signal into an audio signal usable in the user level. The data initialize unit (UG-1 ASIO Drive) 210 initializes the audio signal according to the international audio application standard.

The audio signal processor 212 converts the audio data received from the data initialize unit (UG-1 ASIO Drive) 210 into another audio data, such that it tunes musical sound characteristics of the audio data, records/stores the audio data, reproduces the stored audio data, and converts the stored audio data.

In the meantime, the above-mentioned step (ST-400) for transmitting audio data processed by the PC 200 to the electronic guitar 100, and the above-mentioned step (ST-500) for outputting the audio signal received in the electronic guitar 100 via an external output unit (e.g., a speaker or a headphone) connected to the electronic guitar 100 are executed in a reverse order of the above-mentioned processes, and the signal conversion results of the steps ST-400 and ST-500 are transmitted to the signal processor 118 of the electronic guitar 100. The signal generated from the signal processor 118 receives parallel digital audio data via the DAC 122, converts the received parallel digital audio data into stereo analog audio data, and outputs two-channel analog audio data to the L/R amplifiers 124a and 124b.

In this case, the signal transmitted from the audio signal processor 212 of the PC 220 to the data initialize unit 210 is not equal to an audio signal of a currently-playing electronic guitar 100. Other pre-stored audio signals of other electronic guitars can also be transmitted to the data initialize unit 210, and can be processed by the data initialize unit 210. In this case, the audio signal processor 212 outputs the audio signal stored in the PC 200 to the outside, at the same time receives the played signal of the electronic guitar 100, and can store the played signal in the PC 200 in real time.

The L/R amplifiers 124a and 124b having received the two-channel analog audio data amplify the analog audio signal, and transmit one channel signal to the audio cable port 102 via the relay 112, directly transmit the other channel signal to the audio cable port 102, and output the corresponding audio signal via the speaker 300 or headphone acting as an external output unit connected to the electronic guitar 100.

In the meantime, the audio signal picked up by the electronic guitar 100 (i.e., the analog audio signal picked up by the signal pickup unit 108) is not transmitted to the PC 200, and can be directly transmitted to the external output unit (e.g., the speaker or headphone) via the audio cable port 102.

Therefore, the analog audio signal generated from the electronic guitar 100 by the USB guitar module 106 of the electronic guitar 100 is converted into the digital audio signal, and at the same time is signal-processed to be suitable for the USB standard. As a result, the corresponding audio signal is transmitted to the PC 200, is applied to a variety of application programs stored in the PC 200, and can also be outputted via the speaker of the PC 200. Also, the audio I/O system for use in the guitar according to the present invention receives the mixed/edited signal from the PC 200, performs signal processing on the received signal, outputs the signal-processed resultant signal to the outside via the headphone or speaker 300 connected to the electronic guitar 100, outputs other audio signals pre-stored in the PC 200, at the same time receives the played signal of the electronic guitar 100, and can store the played signal in the PC 200 in real time.

In the meantime, the audio I/O system and method for use in the guitar equipped with the USB interface according to the present invention is not limited to the above-mentioned examples, and is also applicable to other examples without departing from the scope and spirit of the invention.

As apparent from the above description, the audio I/O system and method for use in the guitar equipped with the USB interface according to the present invention converts an analog audio signal generated from an electronic guitar into a digital audio signal using a USB guitar module of the electronic guitar, performs signal processing on the digital audio signal according to the USB standard, transmits the signal-processed resultant signal to a Personal Computer (PC), can employ a variety of application programs stored in the PC, and can also output the corresponding audio signal to the outside via a speaker of the PC. Also, the audio I/O system receives the mixed/edited signal from the PC, performs signal processing on the received signal, can output the corresponding signal to the outside via the headphone or speaker, can allow the PC to output pre-stored audio signals of other guitars, at the same time can play the electronic guitar, and can store the played signal in the PC in real time.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An audio Input/Output (I/O) system for use in a guitar equipped with a Universal Serial Bus (USB) comprising:
an electronic guitar including:
a USB port to implement a bidirectional USB interface,
a USB guitar module for performing signal processing on a guitar's audio signal converted into an electrical signal, transmitting the signal-processed audio signal to the USB port, performing signal processing on the audio signal received from the USB port, and outputting the resultant audio signal to the outside, and
an audio cable port in which an audio cable connector can be inserted; and
a Personal Computer (PC) for receiving the audio signal via the USB guitar module and a USB cable of the electronic guitar, converting the received audio signal according to a prescribed audio signal standard, editing/storing the converted audio signal using a variety of mixing programs and audio edition programs, transmitting pre-stored audio signals of other electronic guitars to the electronic guitar via the USB cable and the USB guitar module, and outputting the resultant audio signal to a speaker and a headphone via the audio cable of the electronic guitar.

2. The audio Input/Output (I/O) system according to claim 1, wherein the electronic guitar includes:
a signal pickup unit for converting variations in a magnetic field signal caused by string vibrations into an electric analog audio signal;
a pickup selection unit for performing a switching operation to output the analog audio signal picked up by the signal pickup unit to a rear end;
an audio cable port for acting as a connection port of the connector of the audio cable suitable for ¼″ TRS standard;
a relay for switching Input/Output (I/O) paths of an audio signal on the condition that it has been connected to the pickup selection unit, the audio cable port, an amplifier, and L/R amplifiers;
an amplifier which is connected to the relay and an ADC (Analog-to-Digital Converter), and amplifies the analog audio signal received from the relay;
an ADC which is connected to the amplifier and a signal processor, and converts the analog signal into a digital signal;
a signal processor which is connected to the ADC and a DAC (Digital-to-Analog Converter), receives a digital audio signal from the ADC, converts the received digital audio signal into another audio signal according to the prescribed USB transfer standard, receives the audio signal suitable for the USB transfer standard from the PC, and converts the received audio signal into a digital audio signal;
an interface unit which is connected to the signal processor and the USB port, receives parallel data suitable for the USB transfer standard from the signal processor, stores the received parallel data in a buffer, converts the stored parallel data into serial data, transmits the serial data, converts the serial data received from an external part into parallel data, and transmits the parallel data to the signal processor;
a USB port which is connected to a rear end of the interface unit, and transmits the audio signal received from the interface unit to the PC via the USB cable connector;
a DAC which is connected to the signal processor and the L/R amplifiers, receives two parallel digital audio data via the signal processor, and converts the received parallel digital audio data into stereo analog audio data; and
L/R amplifiers which are connected to the DAC, the relay, and the audio cable port, and amplify the analog audio signal.

3. The audio Input/Output (I/O) system according to claim 1, wherein the Personal Computer (PC) includes:
a USB port which is contained in the PC, is connected to the USB cable connector, receives an audio signal in the PC via the USB cable connector, or transmits an internal signal of the PC to the electronic guitar via the USB cable connector;
an interface unit which is connected to the USB port and a USB controller, and communicates with Operating Systems (OSs) of different hardware architectures;
a USB controller which is connected to the interface unit and a USB audio drive, converts the audio signal received from the USB port into a signal usable in a kernel, and transmits a signal used in the kernel into other signal according to the USB transfer standard;
a USB audio drive which is connected to the USB controller and a data initialize unit, converts the signal usable in the kernel level into an audio signal usable in a user level, or converts the audio signal usable in the user level into the signal usable in the kernel level;
a data initialize unit which is connected to the USB audio drive and an audio signal processor, initializes the audio signal according to an international audio application standard, converts data suitable for the international audio application into an audio signal, and defines the number of audio channels, an execution frequency, and a buffer size; and
an audio signal processor which is connected to the data initialize unit, converts the audio data received from the data initialize unit, tunes musical sound characteristics of the audio data, records/stores the audio data, reproduces the stored audio data, converts the stored audio data, and transmits the resultant audio data to the data initialize unit.

4. An audio Input/Output (I/O) method for use in a guitar equipped with a Universal Serial Bus (USB) comprising the steps of:
ST-100) converting a signal of the electronic guitar into other signal suitable for a USB standard, and transmitting the converted signal to a Personal Computer (PC);
ST-200) converting a guitar's audio signal received from the PC into another audio signal usable in an application program;
ST-300) editing, mixing, and storing the audio signal using the application program stored in the PC;
ST-400) transmitting audio data processed by the PC to an electronic guitar; and
ST-500) outputting the audio signal received in the electronic guitar via an external output unit of the electronic guitar.

5. The audio Input/Output (I/O) method according to claim 4, wherein the step (ST-100) includes the steps of:
converting variations in a magnetic field signal caused by string vibration of the guitar into an analog audio signal;
transmitting the analog audio signal into a relay contained in a USB guitar module, and transmitting the resultant audio signal to an amplifier according to a switching operation of the relay;
amplifying, by the amplifier, the analog audio signal received from the relay to an ADC (Analog-to-Digital Converter);
converting, by the ADC, the analog signal received from the amplifier to the digital signal;
converting, by a signal processor, the digital signal received from the ADC into another audio signal according to the USB transfer standard;
receiving parallel data suitable for the USB transfer standard in an interface unit, storing the received parallel data in a buffer, and converting the stored parallel data into serial data; and
receiving the serial data in the USB port, and transmitting the received serial data to the PC via the USB cable connector.

6. The audio Input/Output (I/O) method according to claim 4, wherein the step (ST-200) and the step (ST-300) include the step of:
receiving a signal received from the electronic guitar via a USB port of the PC;
allowing an interface unit to communicate with Operating Systems (OSs) of different hardware architectures, allowing a USB controller to receive the signal suitable for the USB transfer standard from the interface unit, and converting the received signal into a signal usable in a kernel;
allowing a USB audio drive to receive the signal usable in the kernel, and converting the received signal into an audio signal usable in a user level;
initializing, by a data initialize unit, the audio signal according to an international audio application standard; and
converting, by an audio signal processor, the audio data received from the data initialize unit into another audio data, tuning musical sound characteristics of the audio data, recording/storing the audio data, reproducing the stored audio data, and converting the stored audio data.

7. The audio Input/Output (I/O) method according to claim 4, wherein the signal transmitted from an audio signal processor of the PC to a data initialize unit is not equal to an audio signal of a currently-playing electronic guitar, and other pre-stored audio signals of other electronic guitars can be transmitted to the data initialize unit,
wherein the audio signal processor outputs the audio signal stored in the PC to the outside, at the same time receives the played signal of the electronic guitar, and can store the played signal in the PC in real time.
